(19) United States
(12) Patent Application Publication
(10) Pub. No.: US 2008/0260254 A1
(43) Pub. Date: Oct. 23, 2008

(54) Automatic 3-D Object Detection

(75) Inventor: Hauke Schramm, Roetgen-Mularshuette (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 12/097,534

(22) PCT Filed: Dec. 18, 2006
(86) PCT No.: PCT/IB2006/054912

§ 371 Date: Jun. 14, 2008

(30) Foreign Application Priority Data
Dec. 22, 2005 (EP) 05112779.3

(51) Int. Cl. G06T 7/00

(52) U.S. Cl. 382/190

(57) ABSTRACT

This invention relates to systems for automatically detecting and segmenting anatomical objects in 3-D images. A method of detecting an anatomical object employing the Generalized Hough Transform, comprising the steps of: a) generating a template object; b) identifying a series of edge points in the template and storing their relative position data and additional identifying information in a table; c) carrying out an edge detection process on the object and storing relative position data and detected points in the object; d) applying a modified Hough Transform to the detected data, in order to identify detected points of the object corresponding to edges of the template, in which the voting weight of each detected point is modified in accordance with a predetermined correspondence between the additional identifying information of the detected data, and the additional identifying information which has been stored for the template, and in which the classification of detected points is also refined by applying further predetermined information relating to model point grouping and base model weights.

This invention relates to systems for automatically detecting and segmenting anatomical objects in 3-D images.

In many medical applications in particular, it is desirable to be able to detect anatomical structures, such as hearts, lungs or specific bone structures, using images produced by various imaging systems, as automatically as possible, i.e. with the minimum of operator input.

The present invention relates to an optimization and shape model generation technique for object detection in medical images using the Generalized Hough Transform (GHT). The GHT is a well-known technique for detecting analytical curves in images [3, 4]. A generalization of this method, which has been proposed in [1], represents the considered object in terms of distance vectors between the object boundary points and a reference point. Thus, a parametric representation is not required which allows the technique to be applied to arbitrary shapes.

By employing gradient direction information, it is possible to identify likely correspondences between model points and edge points in the target image which can be used to increase the accuracy of the localization and speed up the processing time [1]. A well-known shortcoming of the GHT is its large computational complexity and memory requirement in case of higher dimensional problems and large images. Thus, in order to be able to use this technique for object detection in 3-D images, its complexity must be substantially reduced.

One way of doing this is to limit the number of shape model points representing the target object. The present invention provides an automatic procedure for optimizing model point specific weights which in turn can be used to select the most important model point subset from a given (initial) set of points. In addition to that it is described how this technique can be applied to generate shape models for new objects from scratch.

In a preferred embodiment of the invention, a known edge detection technique, such as Sobel Edge Detection, is used to produce an edge image, and the GHT uses the shape of a known object to transform this edge image to a probability function. In practice, this entails the production of a template object, i.e. a generalized shape model, and a comparison of detected edge points in the unknown image, with the template object, in such a way as to confirm the identity and location of the detected object. This is done in terms of the probability of matches between elements of the unknown image, and corresponding elements in the template object. Preferably, this is achieved by nominating a reference point, such as the centroid in the template object, so that boundary points can be expressed in terms of vectors related to the centroid.

In a detected image, edges which may be of interest are identified, for example by Sobel Edge Detection, which allows the gradient magnitude and direction to be derived, so that object boundaries in the image can be better identified. However, this also introduces noise and other artefacts which need to be suppressed, if they are not considered as a potential part of the boundary of a target object.

### 2.1 Overview

Having collected a set of edge points from a target image, it is then necessary to attempt to locate the centroid of the target, on the assumption that it is in a similar relative position to that in the template. However, since the correspondence between the model points and the detected edge points is unknown, the generalized Hough transform attempts to identify the centroid, by hypothesizing that any given detected edge point could correspond to any one of a number of model points on the template, and to make a corresponding number of predictions of the position of the centroid, for each possible case. When this is repeated for all of the detected edge points, and all of the predictions are accumulated, the result can be expressed as a probability function which will (hopefully) show a maximum at the actual position of the centroid, since this position should receive a “vote” from every correctly detected edge point. Of course, in many cases, there will also be an accumulation of votes in other regions, resulting from incorrectly detected points in the image, but with a reasonably accurate edge detection procedure, this should not be a significant problem.

However, in a typical medical image there may be a large number of detected edge points, and accordingly, the “voting” procedure will require considerable computational power, if every one of the detected edge points is considered as possibly corresponding to any one of the edge points in the template. Accordingly, the GHT utilizes the fact that each model point also has other properties such as an associated boundary direction. This means that if a gradient direction of an edge can be associated with every detected edge point, each detected edge point can only correspond to a reduced number of model points with generally corresponding boundary directions. Accordingly, and to allow for the possibility of a fairly significant errors in detection of gradient direction, only edge points whose boundary directions lie within a certain range are considered to be potentially associated with any given model point. In this way, the computational requirement is reduced, and also, the accuracy of the result may be improved by suppressing parts of the image which can be judged as irrelevant.

Each of the model points is assigned a voting weight which is adjusted in accordance with the corresponding edge direction information, and also the grey-level value at the detected point. For example, this may be expressed as a histogram of grey-level distribution, since the expected histogram in a given region can be determined from the corresponding region of the shape model.

Thus, the GHT employs the shape of an object to transform a feature (e.g. edge) image into a multi-dimensional function of a set of unknown object transformation parameters. The maximum of this function over the parameter space determines the optimal transformation for matching the model to the image, that is, for detecting the object. In our framework, the GHT relies on two fundamental knowledge sources:

Shape knowledge (see Section 2.3), usually stored as so-called “R-table”

Statistical knowledge about the grey value and gradient distribution at the object's surface.

The GHT, which has frequently been applied to 2-D or 3-D object detection in 2-D images, is known to be robust to partial occlusions, slight deformations and noise. However, it has also been pointed out by many researchers that the high computational complexity and large memory requirements of the technique limit its applicability to low-dimensional problems. Thus, at the present time, an application of the GHT to object detection in 3-D images, using the full flexibility of a rigid or even a-fine transform, appears prohibitive. Consequently, the GHT has hardly been used for object detection in 3-D images.

The present invention seeks to provide a method of limiting the high complexity of the GHT by limiting the set of shape model points which is used to represent the shape of the target object.

In order to optimally weigh the contribution of a specific model point, in accordance with their importance, for use in a GHT-based classification, it is desirable to combine the information from different model regions or even points into a single decision function. Thus, it is proposed to log-linearly combine a set of base models, representing (groups of) model points, into a probability distribution of the maximum-entropy family. A minimum classification error training can be applied to optimize the base model weights with respect to a predefined error function. The classification of unknown data can then be performed by using an extended Hough model that contains additional information about model point grouping and base model weights. Apart from an increased classification performance, the computational complexity of the Hough transform can be reduced with this technique, if (groups of) model points with small weights are removed from the shape model.

Some embodiments of the present invention will now be described with reference to the accompanying drawings, in which:

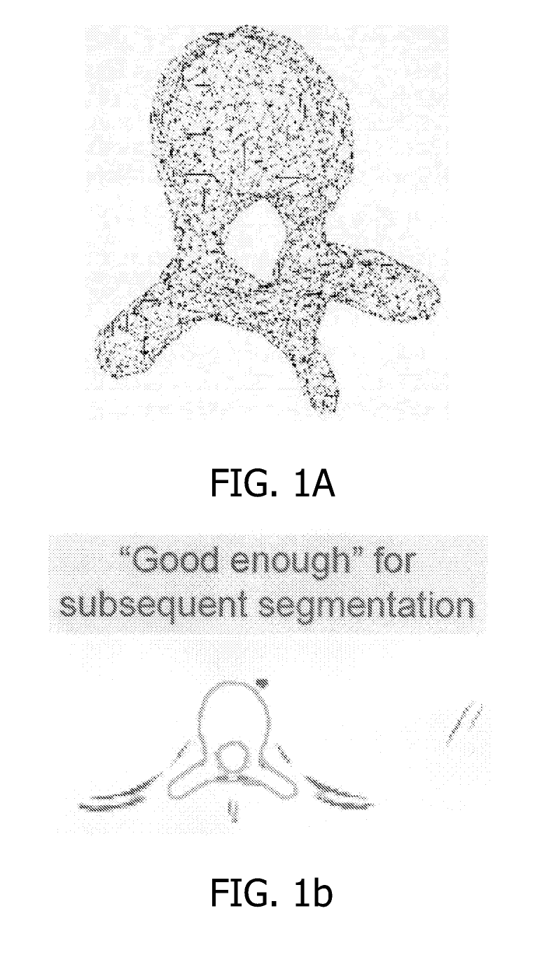

FIG. 1A shows a 3-D mesh model of an anatomical object;

FIG. 1B is an exemplary detected image of a corresponding object in an unknown individual;

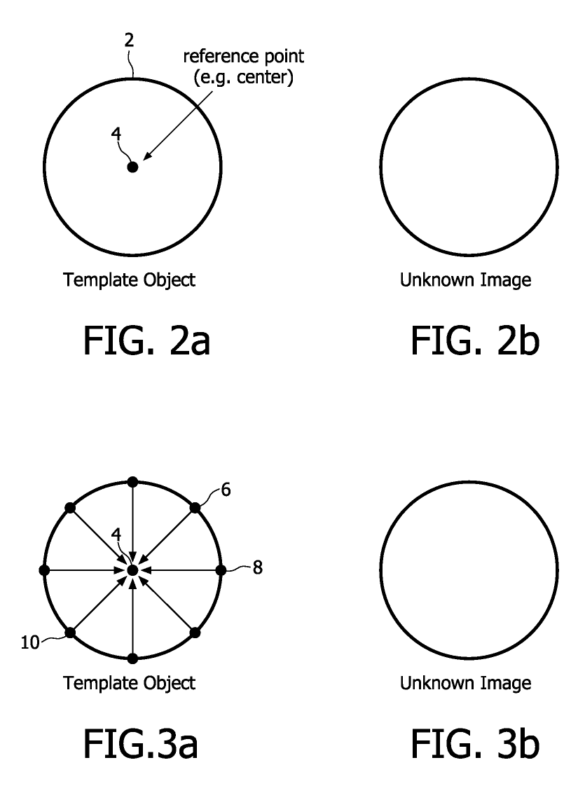

FIG. 2A is a simplified template object for demonstrating the principle of the generalized Hough transform, while FIG. 2B is a corresponding unknown image;

FIGS. 3A, 3B, 4A, 4B, 5A, 5B, 6A, and 6B illustrate respective steps of the shape detection process, using the generalized Hough transform;

FIG. 7A illustrates an example of a more complex 2-D template object;

FIG. 7B illustrates a corresponding Table of detected points.

Referring to FIGS. 1A and 1B, FIG. 1A is a 3-D mesh model of a human vertebra, as a typical example of an object that is required to be detected in a medical image, while FIG. 1B is a typical example of a corresponding detection image, and it will be appreciated that the principle of detection is in practice, generalized from simpler shapes, as shown in the subsequent FIGS. 2 to 6.

FIG. 2A illustrates a simple circular “template object” 2 with a reference point 4 which is the center of the circle 2, and in a practical example might be the centroid of a more complex shape. The corresponding “detected image” is shown in FIG. 2B.

The stages of detection comprise identifying a series of edge points 6, 8, 10 in the template object, as illustrated in FIG. 3A, and storing their positions relative to the reference point 4, for example as a Table containing values of vectors and corresponding edge direction information.

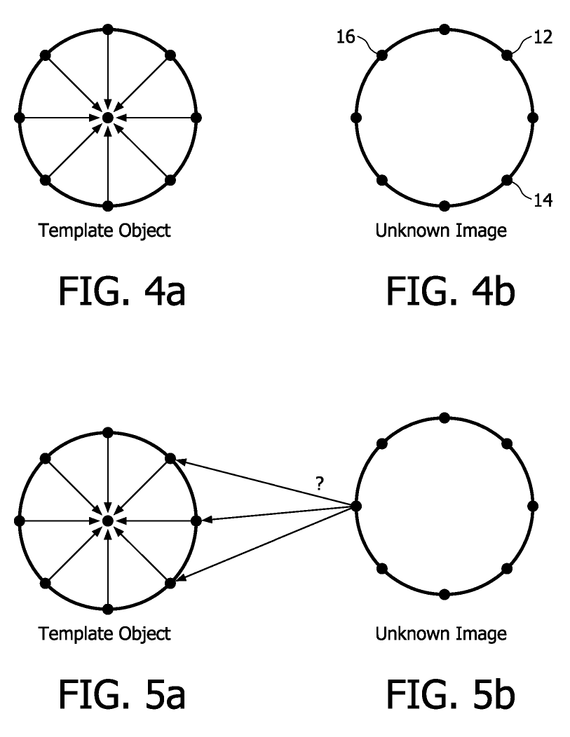

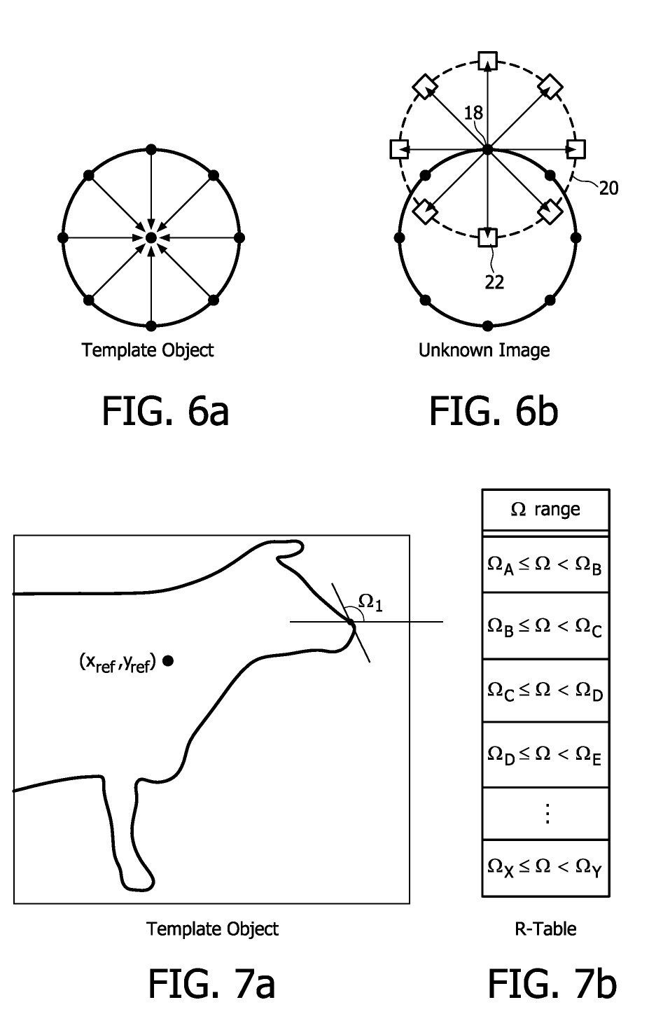

A series of edge points 12, 14, 16 are then identified in the unknown image, as shown in FIG. 4B and the problem to be solved by the generalized Hough transform, as illustrated in FIG. 5, is to determine the correspondence between edge pairs in the unknown image and the template object. As illustrated in FIG. 6, the solution proposed by the generalized Hough transform, is to consider the possibility that any given detected point such as 18 in FIG. 6B could be located on the edge of the unknown image, giving rise to a circular locus illustrated by the dash line 20 in FIG. 6B, for the real “centroid” of the unknown image. It will be appreciated that when all of the detected edge points are considered in this way, and given corresponding “votes” for the real centroid of the unknown image, the highest accumulation of such votes, will, in fact, be at the centroid position 22, where all of the corresponding loci 20 intersect.

FIG. 7 illustrates the application of the principle to a rather more complex template object, as shown in FIG. 7A. In this case, it will be seen that there are a number of detectable edge points located in different regions but having similar gradients Ω which illustrates the much greater computational requirement to detect such an object, compared to the simple template object of FIGS. 3 to 6. One way of dealing with this type of object, is to store the detected points in groups in a so-called “R Table”, as illustrated in FIG. 7B, in which points having gradients falling within different defined ranges are stored in cells corresponding to the ranges.

### 2.2. Detection Procedure

The GHT aims at finding optimal transformation parameters for matching a given shape model, located for example in the origin of the target image, to its counterpart. To this end, a geometric transformation of the shape model M={p₁^{m}, p₂^{m}, . . . p_{Nm}^{m}} is applied which is defined by,

pᵢ^{e}=A·pⱼ^{m}+t (1)

where A denotes a linear transformation matrix and t denotes a translation vector. Each edge point pᵢ^{e} in the feature image is assumed to result from a transformation of some model point pⱼ^{m} according to

pᵢ^{e}=A·pⱼ^{m}+t (1)

If, the other way around, we aim at determining the translation parameters t which may have led to a specific edge point pᵢ^{e}, given a corresponding model point pⱼ^{m} and a transformation matrix A, we are led to

t(pⱼ^{m},pᵢ^{e},A)=pᵢ^{e}−A·pⱼ^{m} (2)

Let us, for the moment, assume that the matrix A is given. Then, this equation can be used to determine the translation parameters t for a pair (Pj″,pf). Since the corresponding model point of a given edge point is in general unknown, we might hypothesize a correspondence between this point and all possible model points and vote for all resulting translation parameter hypotheses in an accumulator array (the so-called Hough space). The set of corresponding model points for a given edge point can be limited by requiring a model point surface normal direction “similar to the edge direction”.

By doing this for all edge points in the feature image, the votes for the best translation solution typically accumulate more than others. Thus, afterwards, the optimal translation parameters can be determined by searching for the cell in the Hough space with the maximum count. If the transformation matrix A is unknown as well the whole procedure must be repeated for each possible setting of the (quantized) matrix parameters. In that case voting is done in a high dimensional Hough space which has an additional dimension for each matrix parameter.

After finalizing the voting procedure for all edge points, the Hough space must be searched for the best solution. By reasonably restricting the quantization granularity of the transformation parameters the complexity of this step remains manageable. The determined “optimal” set of transformation parameters is then used to transform the shape model to its best position and scale in the target image where it can be used for further processing steps like segmentation.

### 2.3. Shape Model Generation

The GHT is mainly based on shape information and therefore requires a geometrical model for each considered object. Since anatomical objects typically have a very specific surface, in most cases a surface shape model is expected to be sufficient for detection. However, additional information about major internal structures (e.g. heart chambers) may be given as well to further support discrimination against similar objects. Presently, the generation of shape models for the generalized Hough transform requires substantial user interaction and has to be repeated each time a new shape is introduced. Another drawback of the current shape acquisition technique is that the generated shape model is well adapted only to a single training shape and does not take into account any shape variability. Thus, a new technique for shape model generation is proposed which is based on a minimum classification error training of model point specific weights. This technique reduces the necessary user interaction to a minimum, only requesting the location of the shape in a small set of training images and, optionally, a region of interest. In addition to that, the generated model incorporates the shape variability from all training shapes. It is therefore much more robust than a shape model which is based on only a single training shape.

To this end, the object detection task is described as a classification task (see below) where input features (e.g. edge images) are classified into classes, representing arbitrary shape model transformation parameters (for matching the shape model to the target image). The applied classifier (log-linearly) combines a set of basic knowledge sources. Each of these knowledge sources is associated to a specific shape model point and represents the knowledge introduced into the GHT by this point. In a minimum classification error training the individual weights of the basic (model point dependent) knowledge sources are optimized. After optimization, these weights represent the importance of a specific shape model point for the classification task and can be used to eliminate unimportant parts of the model (cf. Section 2.3.2).

### 2.3.1 Minimum Classification Error Training of Model Point Weights

The following example of an embodiment of the invention illustrates the classification of image feature observations xₙ (the features of a complete image or a set of images) into a class kε{1, . . . K} using the generalized Hough transform. The class k may represent an object location, or arbitrary transformation parameters. To solve this classification task, a set of M posterior probability base models is pⱼ(k|xₙ), j=1, . . . M is applied. These base model distributions represent single Hough model points or groups of points and may be derived from the Hough space voting result on some training volume data by the relative voting frequencies:

$${p}_{j} ( k \vert {x}_{n} ) = \frac{N ( j , k , {x}_{n} )}{{\sum }_{∀ {k}^{′}} N ( j , {k}^{′} , {x}_{n} )} \qquad ( 3 )$$

Here, N(j,k,xₙ) represents the number of votes by model point (or region) j for hypothesis k if the features xₙ have been observed. Alternatively, the probability distribution could be estimated by a multi-modal Gaussian mixture.

In the next step, the base models are log-linearly combined into a probability distribution of the maximum-entropy family [3]. This class of distributions ensures maximal objectivity and has been successfully applied in various areas.

$$\begin{matrix}{p}_{Λ} ( k \vert x ) = {e}^{- log Z ( Λ , {x}_{n} ) + {\sum }_{j = 1}^{M} {λ}_{j} log {p}_{j} ( k \vert {x}_{n} )} & ( 4 ) \\ The value Z ( Λ , {x}_{n} ) is a normalization constant with & ( 5 ) \\ Z ( Λ , {x}_{n} ) = {\sum }_{{k}^{′}} exp [ {\sum }_{j = 1}^{M} {λ}_{j} log {p}_{j} ( {k}^{′} \vert {x}_{n} ) ] & ( 6 )\end{matrix}$$

The coefficients Λ(λ₁, . . . λ_{M})^{T} can be interpreted as weights of the models j within the model combination.

As opposed to the well-known maximum entropy approach, which leads to a distribution of the same functional form, this approach optimizes the coefficients with respect to a classification error rate of the following discriminant function:

$$log \frac{{p}_{Λ} ( k \vert {x}_{n} )}{{p}_{Λ} ( {k}_{n} \vert {x}_{n} )} = {\sum }_{j = 1}^{M} {λ}_{j} log \frac{{p}_{j} ( k \vert {x}_{n} )}{{p}_{j} ( {k}_{n} \vert {x}_{n} )} \qquad ( 7 )$$

In this equation, kₙ denotes the correct hypothesis. Since the weight λⱼ of the base model j within the combination depends on its ability to provide information for correct classification, this technique allows for the optimal integration of any set of base models. Given a set of training volumes n=1, . . . , H with correct class assignment it is possible to generate a feature sequence xₙ for each volume. By performing a preliminary classification with equal weights (i.e., λⱼ=const ∀j), a set of rival classes k≠kₙ can be determined. In order to quantify the classification error for each rival class k, an appropriate distance measure Γ(kₙ, k) must be selected. Of course, this choice strongly depends on the class definition. In case of a translation classification problem for example, where the solution is a simple 2D or 3D position vector, the euclidean distance between the correct point and its rival could be used. An even simpler idea is to use a binary distance measure, which is ‘1’ for the correct class and ‘0’ for all others.

The model combination parameters should then minimize the classification error count E(Λ)

$$E ( Λ ) = {\sum }_{n = 1}^{H} Γ ( {k}_{n} , \text{arg} {max}_{k} ( log \frac{{p}_{Λ} ( k \vert {x}_{n} )}{{p}_{Λ} ( {k}_{a} \vert {x}_{n} )} ) ) \qquad ( 8 )$$

on representative training data to assure optimality on an independent test set. As this optimization criterion is not differentiable, it is approximated by it by a smoothed classification error count:

$${E}_{S} ( Λ ) = {\sum }_{n = 1}^{H} {\sum }_{k \neq {k}_{n}} Γ ( k , {k}_{n} ) S ( k , n , Λ ) , \qquad ( 9 )$$

where S(k, n, Λ) is a smoothed indicator function. If the classifier (see below) selects hypothesis k, S(k, n, Λ) should be close to one, and if the classifier rejects hypothesis k, it should be close to zero. A possible indicator function with these properties is

$$S ( k , n , Λ ) = \frac{{{p}_{Λ} ( k \vert {x}_{n} )}^{η}}{{\sum }_{{k}^{′}} {{p}_{Λ} ( {k}^{′} \vert {x}_{n} )}^{η}} , \qquad ( 10 )$$

where η is a suitable constant. An iterative gradient descent scheme is obtained from the optimization of E_{S}(Λ) with respect to Λ[3].

This iteration scheme reduces the weight of model points or groups which

$${λ}_{j}^{( 0 )} = 0 ( Uniform Distribution ) \\ {λ}_{j}^{( I + 1 )} = {λ}_{j}^{( I )} - ɛ \cdot η {\sum }_{u = 1}^{H} {\sum }_{k \neq {k}_{n}} S ( k , n , {Λ}^{( I )} ) \cdot \tilde{Γ} ( k , n , {Λ}^{( I )} ) \cdot log \frac{{p}_{j} ( k \vert {x}_{n} )}{{p}_{j} ( {k}_{n} \vert {x}_{n} )} \\ {Λ}^{( I )} = {( {Λ}_{1}^{( I )} , … , {λ}_{M}^{( I )} )}^{T} \\ j = 1 , … , M \\ \tilde{Γ} ( k , n , Λ ) = Γ ( k , {k}_{n} ) - {\sum }_{{k}^{′} \neq {k}_{n}} S ( {k}^{′} , n , Λ ) Γ ( {k}^{′} , {k}_{n} ) . \qquad ( 11 )$$

favor weak hypothesis (i.e. distance to correct hypothesis is large) while increasing the weight of base models which favor good hypothesis.

With a set of optimized weights, the classification of new (unknown) images is performed with an extended Hough model, that incorporates information about model point position, grouping (i.e. the link between model points and base models), and base model weights (as obtained from minimum classification error training). The classification algorithm proceeds as follows:

1. Apply GHT using input features x to fill the Hough space accumulator.
2. Determine pⱼ(k|x) for all base models j and classes k, using the accumulator information (e.g. with equation (3)).
3. Compute the discriminant function (7) for each class k with the λⱼ obtained from minimum classification error training.

Decide for the class with highest discriminant function.

In operation of the preferred method of the invention, the algorithm for automatic generation of shape-variant models therefore proceeds as follows, assuming there are a plurality of training values:

1. Feature detection is applied (e.g. Sobel edge detection) on all training volumes;
2. For each training volume: the user is asked to indicate the object location or locations;
3. A spherical random scatter plot of model points is generated using two input parameters: (1) number of points, (2) concentration decline in dependence of the distance to the center;
4. The center of the plot is moved to each given object location, and only points which overlap with a contour point in at least one volume are retained. Points with no overlap in any volume are deleted;
5. A procedure is executed for automatically determining the importance of specific model points (or model point regions) for the classification task;
6. Unimportant model points are removed.

The generated shape-variant model and its model weights can directly be used in a classification based, for instance, on the generalized Hough Transform [1].

In an alternative scenario, the user defines a ‘region of interest’ in one training volume. The features (e.g. contour points) of this region are used as an initial set of model points, which is optionally expanded by additional model points that represent the superposition of noise. This (expanded) set of model points is then used instead of the spherical random scatter plot for the discriminative model point weighting procedure.

### REFERENCES

1. D. H. Ballard, “Generalizing the hough transform to detect arbitrary shapes,” Tech. Rep. 2, 1981.
2. P. Beyerlein, “Diskriminative Modellkombination in Spracherkennungssystemen mit gro″sem Wortschatz”, Dissertation, Lehrstuhl fur Informatik VI, RWTH Aachen, 1999
3. P. V. C. Hough, “Method and means for recognizing complex patterns,” tech. rep., 1962.
4. R. O. Duda and P. E. Hart, “Use of the Hough transform to detect lines and curves in pictures,” tech. rep., 1972.

1. A method of detecting an anatomical object employing the Generalized Hough Transform, comprising the steps of:
a) generating a template object;
b) identifying a series of edge points in the template and storing their relative position data and additional identifying information in a table;
c) carrying out an edge detection process on the object and storing relative position data and additional identifying information corresponding to detected points in the object;
d) applying a modified Hough Transform to the detected data, in order to identify detected points of the object corresponding to edges of the template, in which the voting weight of each detected point is modified in accordance with a predetermined correspondence between the additional identifying information of the detected data, and the additional identifying information which has been stored for the template, and in which the classification of detected points is also refined by applying further predetermined information relating to model point grouping and base model weights.

2. A method according to claim 1 in which the model point grouping information is derived by log-linearly combining a set of base models representing groups of model points, into a probability distribution of the maximum entropy family.

3. A method according to claim 1 in which the base model weights are optimized by minimum classification error training with respect to a predefined error function.
$${p}_{j} ( k \vert {x}_{n} ) = \frac{N ( j , k , {x}_{n} )}{{\sum }_{∀ {k}^{′}} N ( j , {k}^{′} , {x}_{n} )} \qquad ( 3 )$$

4. A method of classifying unidentified detected images, comprising the steps of:
a) applying the generalized Hough Transform using input features x to fill the Hough space accumulator.
b) determining pⱼ(k|x) for all base models j and classes k using the accumulator information using
$$log \frac{{p}_{Λ} ( k \vert {x}_{n} )}{{p}_{Λ} ( {k}_{n} \vert {x}_{n} )} = {\sum }_{j = 1}^{M} {λ}_{j} log \frac{{p}_{j} ( k \vert {x}_{n} )}{{p}_{j} ( {k}_{n} \vert {x}_{n} )} \qquad ( 7 )$$
c) computing the discriminant function
for each class k with the λⱼ obtained from minimum classification error training, and
d) choosing the class with the highest discriminant function.

5. A method according to claim 1 in which the additional identifying information includes the gradient magnitude at each point and/or a grey level magnitude at each point.

6. A method according to claim 1 in which the predetermined correspondence between the respective sets of additional identifying information comprises a range relationship, whereby the voting weight is modified if the additional identifying information of the detected point falls outside a predetermined range compared to the additional identifying information of an edge point in the template having corresponding relative position data.

7. A method according to claim 1 wherein the relative position data for each point comprises distance and orientation data relative to a reference point in the template.

8. A method according to claim 1 in which the information from different model regions is combined into a single decision function so that the classification of unknown data can be performed using an extended Hough model containing additional information relating to model point grouping and base model weights.

9. A method of generating a shape-variant model for use in automatic 3-D object detection comprising the steps of:
a) applying feature detection on all training volumes;
b) manually indicating object location or locations;
c) generating a random scatter plot using as input parameters:
i) number of points
ii) concentration decline in dependence on distance to the center;
d) moving the center of the plot to each given object location in turn, and removing points which do not overlap in at least one object volume;
e) automatically determining the importance of specific model points or regions for the classification task; and
f) removing unimportant model points.
